(19) United States
(12) Patent Application Publication
(10) Pub. No.: US 2024/0159899 A1
(43) Pub. Date: May 16, 2024

(54) FISH DETECTION SYSTEM INCLUDING TRANSDUCER MOUNTED TO TROLLING MOTOR SHAFT

(71) Applicant: Michael L. Roller, Purdy, MO (US)

(72) Inventor: Michael L. Roller, Purdy, MO (US)

(21) Appl. No.: 18/506,297

(22) Filed: Nov. 10, 2023

Related U.S. Application Data
(60) Provisional application No. 63/425,499, filed on Nov. 15, 2022.

(51) Int. Cl. G01S 15/96; A01K 75/00; B63H 20/00; B63H 20/02; B63H 20/14; G01S 7/521; G01S 15/89

(52) U.S. Cl. CPC G01S 15/96; A01K 75/00; B63H 20/007; B63H 20/02; B63H 20/14; G01S 7/521; G01S 15/89

(57) ABSTRACT

A fish detection system including a trolling motor assembly, a transducer assembly, and a motor. The trolling motor assembly includes a shaft, a motor, and a propeller, the motor and propeller being mounted to the shaft. The transducer assembly includes a transducer for capturing underwater image information and a bracket for attaching the transducer of the transducer assembly to the shaft of the trolling motor assembly, the bracket defining an opening configured to receive the shaft. The motor is configured to rotate the transducer attached to the bracket relative to the shaft to provide an adjustable field of view of the transducer.

### CROSS-REFERENCE TO RELATED APPLICATION

This application claims priority to and the benefit of U.S. Provisional Patent Application Ser. No. 63/425,499, entitled “FISH DETECTION SYSTEM INCLUDING TRANSDUCER MOUNTED TO TROLLING MOTOR SHAFT,” filed Nov. 15, 2022, the contents of which are incorporated herein in their entirety.

### TECHNICAL FIELD

The field of disclosure relates generally to a fish detection system, and, more particularly, to a fish detection system including a transducer mounted to a shaft of a trolling motor.

### BACKGROUND

Fish detection systems assist with detecting fish in lakes and other bodies of water and provide various underwater information such as water depth, distribution of fish, and the condition of the body of water. Many fish detection systems use sound navigation and ranging (SONAR) and comprise a transducer that emits sound signals into the water that rebound when they strike a fish. The location of the fish may be determined based on the time it takes for the reflected waves to return to the transducer. The fish detection system detects reflected energy and converts it into an image on a display device.

In some fish detection systems, the fish finder, or transducer, may be attached to a trolling motor, which is a self-contained unit that may include a motor, propeller, and controls. Trolling motors may be affixed to a boat via a shaft. Trolling motors are often the secondary means of propulsion for the boat and enable a person to fish methodically and quietly. For example, trolling motors enable a boat to stay in one spot when fighting against current or wind without deploying a physical anchor. A trolling motor may be powered by battery, gasoline, or other fuel, and it may be controlled via foot or hand control switches connected to the motor.

In some embodiments, the fish finder may be fixedly attached to and operated with the trolling motor. As a result, operation of the fish finder may be limited or impeded by the trolling motor. For example, the location of the fish may be in a direction that is different from the direction of the trolling motor, and/or the area measured by the fish finder may not be visible to the person operating the trolling motor. Further, the trolling motor may sometimes interfere with the fish finder, thereby reducing the effectiveness of the fish detection system. Moreover, the fish finder may not have a field of view that captures a complete view of underground locations around the boat.

Accordingly, there is a need for a fish detection system including a transducer that may be operated independently of the trolling motor and that provides enhanced features in comparison to previous fish detection systems.

### BRIEF DESCRIPTION

In one aspect, a fish detection system is provided. The fish detection system includes a trolling motor assembly including a shaft, a motor, and a propeller, the motor and propeller being mounted to the shaft. The fish detection system also includes a transducer assembly including a transducer for capturing underwater image information and a bracket for attaching the transducer of the transducer assembly to the shaft of the trolling motor assembly, the bracket defining an opening configured to receive the shaft. The fish detection system further includes a motor configured to rotate the transducer attached to the bracket relative to the shaft to provide an adjustable field of view of the transducer.

In another aspect, a transducer assembly is provided. The transducer assembly includes a first bracket element and a second bracket element configured to couple to the first bracket element. The first bracket element and the second bracket element, when coupled, form a first gear comprising an opening configured to receive a trolling motor shaft. The transducer assembly also includes a second gear configured to mate with the first gear, a transducer attached to the second gear, and a motor configured to induce rotation of at least one of the first gear or the second gear and rotate the transducer relative to the trolling motor shaft to provide an adjustable field of view of the transducer.

In another aspect, a bracket assembly is provided. The bracket assembly includes a bracket comprising a first bracket element and a second bracket element. The first bracket element is configured to couple to the second bracket element. The first bracket element and the second bracket element, when coupled, form a first gear comprising an opening configured to receive a trolling motor shaft. The bracket assembly also includes an electric motor and a second gear mounted on the electric motor. The second gear is configured to mate with the first gear, and the electric motor is configured to induce rotation of the second gear. The bracket assembly further includes a face plate configured to receive a transducer. The face plate is arranged to rotate about the bracket when the electric motor induces rotation of the second gear.

### BRIEF DESCRIPTION OF THE DRAWINGS

FIG. 1 is a perspective view of one suitable embodiment of a fish detection system for use on a boat, the fish detection system including a transducer assembly, an imaging module, and a display.

FIG. 2 is a block diagram of the fish detection system shown in FIG. 1.

FIG. 3 is a side view of a transducer assembly for use with the fish detection system shown in FIG. 1, according to one suitable embodiment.

FIG. 4 is a top view of a bracket for use with the transducer assembly shown in FIG. 3.

The following detailed description is to be read with reference to the figures, in which like elements in different figures have like reference numerals. The figures, which are not necessarily to scale, depict selected embodiments and are not intended to limit the scope of the present disclosure. Skilled artisans will recognize the examples provided herein have many useful alternatives and fall within the scope of the present disclosure.

### DETAILED DESCRIPTION

A fish detection system including a transducer and a bracket for mounting the transducer is disclosed. More particularly, the bracket is configured to couple the transducer to a shaft of a trolling motor. The disclosed bracket provides several advantages, including the ability to move the transducer independently of the trolling motor up to 360 degrees and/or enabling the transducer to have a 360 degree range of detection. The terms “transducer” and “fish finder” are used interchangeably throughout the foregoing description.

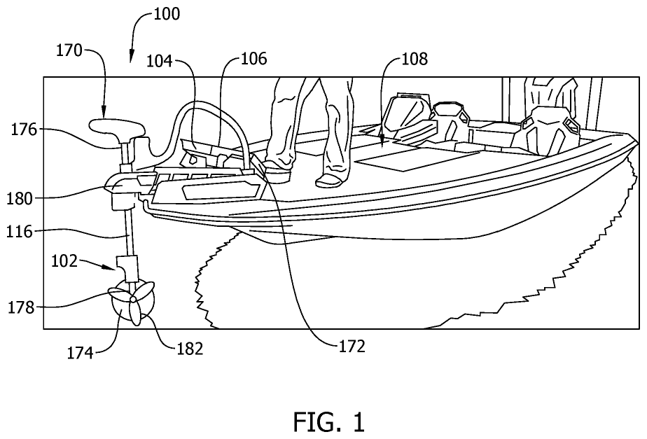

FIG. 1 illustrates a fish detection system 100, according to one suitable embodiment of the present disclosure. The fish detection system 100 includes a transducer assembly 102, a trolling motor assembly 170, an imaging module 104, and a display device 106. The transducer assembly 102, the imaging module 104, and/or the display device 106 may suitably be mounted to or otherwise integrated into a marine vessel (e.g., a boat 108). The transducer assembly 102 may include a stock off-the-shelf sonar system, or a custom sonar system. Non-limiting examples of a commercially available system for use in the transducer assembly 102 include the STRIKER™ fish finders available from GARMIN®.

As seen in FIG. 1, the trolling motor assembly 170 includes a shaft 116, a motor 174, and a propeller 182. The motor 174 and the propeller 182 are connected to the shaft 116. The shaft 116 comprises a first end 176 and a second end 178. The shaft 116 is configured to be attached to an edge of a boat 108 between the first end 176 and a second end 178. For example, a support 180 is attached to the boat 108 and supports the shaft 116 between the first end 176 and the second end 178.

The shaft 116 is configured to extend into the water such that the propeller 182 is at least partially submerged. During operation, the motor 174 is configured to rotate the propeller 182 and subsequently propel the boat in a desired direction or maintain the boat in one spot when fighting against current or wind without deploying a physical anchor. The trolling motor assembly 170 is controlled via a control device such as one or more foot pedals 172. For example, the foot pedals 172 may be used to activate/deactivate the motor 174 and/or to rotate the trolling motor assembly 170 and thereby change the propulsion force provided by the trolling motor assembly 170.

The fish detection system 100 may include an internal power source, such as a battery, configured to supply power for components of the fish detection system 100. However, in some suitable embodiments, any component of the fish detection system 100 may receive power from an external power source such as a power source on board the vessel.

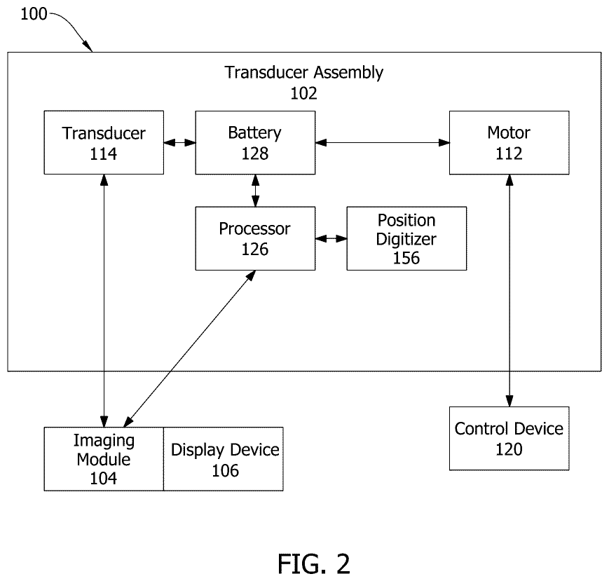

FIG. 2 is a block diagram of the fish detection system 100 of FIG. 1. The fish detection system 100 includes the transducer assembly 102, the imaging module 104, the display device 106, and a control device 120. The transducer assembly 102 comprises a transducer 114 as well as an electric motor 112 configured to move the transducer 114 in different positions. For example, the electric motor 112 is configured to rotate the transducer 114 axially about the shaft 116. The electric motor 112 is communicatively coupled to and controlled by the control device 120, as discussed in more detail below. The transducer assembly 102 further comprises a processor 126 and a radial position digitizer 156, discussed in more detail below. The processor 126 may be communicatively coupled to the imaging module 104 and the display device 106 via wired or wireless (e.g., Bluetooth®, Wi-Fi, or any other wireless communication technique known in the art) communications. The transducer assembly 102 may further comprise a battery 128 configured to power one or more components of the transducer assembly 102.

The transducer assembly 102 is communicatively coupled to the imaging module 104 and the display device 106. For example, the transducer assembly 102 may communicate via wired or wireless communication. In some embodiments, the transducer 114 of the transducer assembly 102 receives reflected sonar signals at a first location and wirelessly communicates the received signals to the imaging module 104 and the display device 106 at a second location mounted on the boat 108 using Bluetooth®, Wi-Fi, or any other wireless communication technique known in the art. In some embodiments, the imaging module 104 and/or the display device 106 may be incorporated into a personal computing device such as a smartphone or a tablet.

The transducer 114 of the transducer assembly 102 is configured to provide image information for underwater locations. The transducer 114 transmits and receives signals. In some embodiments, the transducer 114 transmits sonar signals (also referred to herein as a sonar beam) into a body of water. Objects in the body of water (e.g., fish) obstruct the path of the sonar signals transmitted by the transducer 114 and produce reflected signals or echoes in response, which are received by the transducer 114. Although the transducer assembly 102 is shown including one transducer 114, any numbers of transducers may be included in the transducer assembly 102.

The transducer 114 is attached to the shaft 116 of the trolling motor assembly 170. For example, the transducer 114 is mounted to the shaft 116 such that the transducer 114 is positioned underwater in a use position. In addition, the transducer assembly 102 is configured to switch between the use position and a stow position. For example, the transducer assembly 102 is attached to the shaft 116 of the trolling motor assembly 170 and pivots relative to the boat 108 independent of the trolling motor assembly 170 between the use position and the stow position. In addition, in some embodiments, the depth of the transducer 114 in the water may be adjusted by lowering or raising the shaft 116 and/or the transducer 114 relative to the boat 108. In addition, the mount of the transducer assembly enables the transducer 114 to move independently of the trolling motor assembly 170 (e.g., the transducer 114 rotates about a longitudinal axis of the shaft 116) and provide an adjustable field of view. Therefore, a user may be able to control the boat 108 via the trolling motor assembly 170 and independently look for fish via the transducer 114.

The imaging module 104 may be communicatively coupled to the transducer 114 and process the sonar signals received by the transducer 114. The imaging module 104 generates sonar images based on the processed sonar signals. The sonar images are displayed on the display device 106. For example, the display device 106 is communicatively coupled with the imaging module 104 and the transducer assembly 102, and displays the determined location of fish on a user interface. In some embodiments, the location of fish is indicated using one or more colors and/or symbols on the map displayed on the user interface. In some embodiments, the display device 106 is a digital screen. The sonar images displayed on display device 106 are associated with the underwater environment, specifically depicting the location of the underwater objects that obstruct and reflect the sonar signals received by the transducer 114.

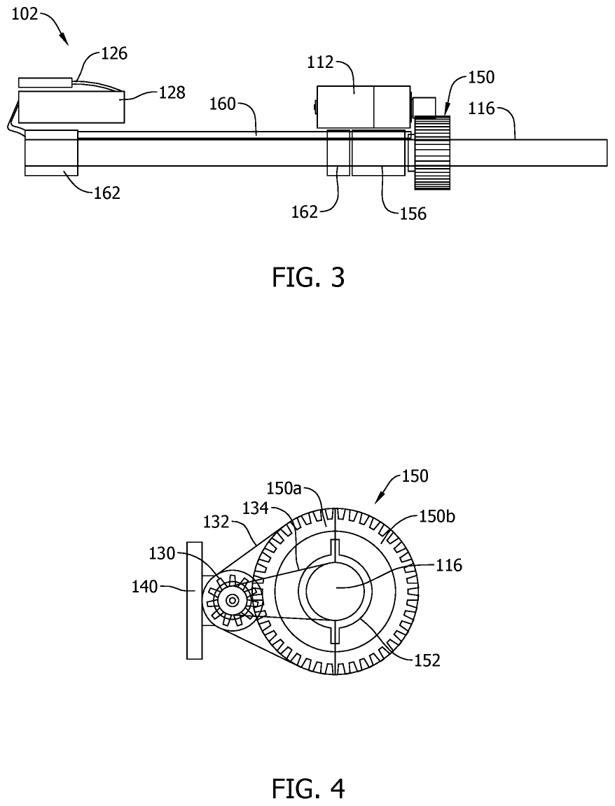

FIG. 3 is a side view of the transducer assembly 102 in accordance with an embodiment. Components of the transducer assembly 102 are mounted on the shaft 116 of the trolling motor assembly 170 (shown in FIG. 1). In some embodiments, the distal portion of the shaft 116 is located such that at least a portion is submerged underwater when in use, as described above.

In some embodiments, the electric motor 112 comprises a 12-volt operative reversible motor. The electric motor 112 may be controlled via a control device 120 (see FIG. 2) configured to receive an input from a user. For example, in some embodiments, the control device 120 may comprise a foot switch, a hand switch, or a remote. The control device 120 may be communicatively connected to the electric motor 112 and may control the direction of the rotation of the electric motor 112. For example, the control device 120 may comprise controls for rotating the electric motor 112 in a clockwise direction and/or a counterclockwise direction. In some embodiments, the electric motor 112 may be communicatively coupled to the control device 120 wirelessly via Bluetooth®, near-field communication, WiFi, or any other wireless communication methods known in the art. In other embodiments, the electric motor 112 may be connected to the control device 120 via one or more cables.

With reference to FIGS. 3 and 4, the transducer assembly 102 further comprises a bracket 150. The bracket 150 is configured to couple the transducer 114 (see FIG. 2) to the shaft 116. In the embodiment illustrated in FIG. 4, the bracket 150 comprises a first bracket element 150a and a second bracket element 150b. The first bracket element 150a and the second bracket element 150b are configured to couple to one another. Each of the first bracket element 150a and the second bracket element 150b in the illustrated embodiment has a semi-circle shape such that when they are coupled together, the bracket 150 is ring-shaped and defines an opening 152. The opening 152 is sized and shaped to receive the shaft 116 of the trolling motor assembly 170. Therefore, since the elements 150a, 150b of the bracket 150 may be coupled and uncoupled, the bracket 150 may be removably affixed to the shaft 116 or moved to different locations along the length of the shaft.

The first bracket element 150a and the second bracket element 150b may be coupled together and/or to the shaft 116 via one or more screws. Additionally, or alternatively, the first bracket element 150a may comprise a component that is configured to mate with a component of the second bracket element 150b. Additionally, or alternatively, the first bracket element 150a and the second bracket element 150b may be coupled to one another and/or to the shaft 116 via an adhesive, epoxy, or the like. However, as will be appreciated by one having ordinary skill in the art, the first bracket element 150a and the second bracket element 150b may be coupled to each other and/or the shaft 116 by various different mechanisms.

An outer surface of the first bracket element 150a and the second bracket element 150b comprises teeth, thereby forming a gear. The bracket 150 is configured to mate with a gear mounted on an output shaft of the electric motor 112. The motor shaft mounted gear 130 is configured to rotate upon activation of the electric motor 112. In some embodiments, the motor shaft mounted gear 130 has a smaller diameter than the radius of the bracket 150. In some embodiments, there are one or more gear belts connecting the bracket 150 and the motor shaft mounted gear 130. For example, in the embodiment illustrated in FIG. 4, a gear belt 132 surrounds an outer portion of the bracket 150 and an outer portion of the motor shaft mounted gear 130. In addition, a gear belt 134 extends along the inner edge of the bracket 150 and an inner edge of the motor shaft mounted gear 130 and surrounds the shaft 116 and the output shaft to the electric motor 112. The gear belts 132, 134 may be configured to rotate with the bracket 150 and/or the motor shaft mounted gear 130. Suitably, as the electric motor 112 and the motor shaft mounted gear 130 rotate, the gear belts 132, 134 provide a tension force that both maintains engagement of the bracket 150 and the motor shaft mounted gear 130 and maintains position of the bracket 150 and the motor shaft mounted gear 130 relative to the shaft 116. However, as will be appreciated by one having ordinary skill in the art, more, fewer, or no gear belts may be used.

As seen in FIG. 4, the transducer assembly 102 includes a face plate 140 connected to the motor shaft mounted gear 130. In suitable embodiments, the transducer 114 (shown in FIG. 2) is mounted on the face plate 140. The face plate 140 includes a flat mounting surface and is oriented in a substantially vertical position, e.g., a plane defined by the flat mounting surface of the face plate 140 is substantially parallel to and does not intersect a rotational axis of the shaft 116.

Referring to FIGS. 1-4, during operation, when the electric motor 112 receives an input from a user via the control device 120 (shown in FIG. 2), the electric motor 112 causes the motor shaft mounted gear 130 to rotate around the bracket 150, thereby causing the transducer 114 attached to the motor shaft mounted gear 130 to rotate around the bracket 150 and enabling the transducer to detect fish in numerous directions. For example, the bracket 150 is fixed in position relative to the shaft 116. The intermeshing teeth of the motor shaft mounted gear 130 and the bracket 150 cause the motor shaft mounted gear 130 to rotate about the bracket 150 and consequentially the shaft 116 when the electric motor 112 induces rotation of the motor shaft mounted gear 130. In the illustrated embodiment, teeth extend continuously around the entire circumferences of the motor shaft mounted gear 130 and the bracket 150 such that the motor shaft mounted gear 130 can rotate around the entire circumference of the bracket 150 and provide a complete 360 degree field of view for the transducer 114.

Further, the bracket 150 enables the transducer 114 to rotate independently of the trolling motor assembly 170. In some embodiments, the bracket 150 is configured to enable the motor shaft mounted gear 130 to rotate 360 degrees about the bracket 150. This in turn enables the transducer 114 to capture or have a field of view of 360 degrees. In other embodiments, the motor shaft mounted gear 130 may rotate less than 360 degrees about the bracket 150 but may rotate enough to allow the transducer 114 to have a field of view of 360 degrees. In some embodiments, when the transducer assembly 102 is in use (i.e., being used to detect fish underwater), a distal portion of the shaft 116 comprising the bracket 150 and the face plate 140 holding the transducer may be submerged underwater.

The transducer assembly 102 may further comprise a radial position digitizer 156 configured to determine a position of the transducer. More particularly, the radial position digitizer 156 may be configured to determine a location of the motor shaft mounted gear 130, the face plate 140, the output shaft, the shaft 116, and/or the bracket 150 to keep track of where the transducer is currently located with respect to the shaft 116. More particularly, the radial position digitizer 156 may be configured to determine where the motor shaft mounted gear 130, the electric motor 112, the face plate 140, and/or the transducer 114 is located relative to the circumference of the bracket 150 or the shaft 116. By determining the location of at least one component of the transducer assembly 102 with respect to the bracket 150, the direction that the transducer 114 is pointing may be determined. In some embodiments, the radial position digitizer 156 is located adjacent to the bracket 150.

In some embodiments, the radial position digitizer 156 may be communicatively coupled to the processor 126 (see FIG. 2) via wired or wireless communications. For example, in some embodiments, the radial position digitizer 156 may be communicatively coupled to the processor 126 via a cable, e.g., a cable 160. Alternatively, the radial position digitizer 156 may be communicatively coupled to the processor 126 wirelessly via Bluetooth®, near-field communication, WiFi, or any other wireless communication methods known in the art. In some embodiments, one or more of the electric motor 112, the radial position digitizer 156, and/or the transducer 114 may be connected to the battery 128 via the cable 160 such that the battery 128 is able to supply energy to one or more of the components. In other embodiments, one or more additional batteries (not shown) may be located on the distal end of the shaft 116 to supply energy to the electric motor 112, the radial position digitizer 156, and/or the transducer 114. In embodiments where components are connected via cables, the transducer assembly 102 may further comprise one or more conductive connectors 162 in order to allow electrical current to flow, either to power a device or transmit signals. The conductive connectors 162 are arranged to provide an electrical connection between the cable 160 and the electric motor 112 and/or the transducer 114 as the electric motor 112 and/or the transducer 114 rotate relative to the shaft 116. For example, the conductive connectors 162 may comprise a shielded slip ring connector.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fish detection system comprising:
a trolling motor assembly including a shaft, a motor, and a propeller, the motor and propeller being mounted to the shaft;
a transducer assembly including a transducer for capturing underwater image information and a bracket for attaching the transducer of the transducer assembly to the shaft of the trolling motor assembly, the bracket defining an opening configured to receive the shaft; and
a motor configured to rotate the transducer attached to the bracket relative to the shaft to provide an adjustable field of view of the transducer.

2. The fish detection system of claim 1, further comprising an internal power source configured to supply power for components of the fish detection system.

3. The fish detection system of claim 1, further comprising a display device to visually display the image information obtained by the transducer.

4. The fish detection system of claim 3, wherein the display device is incorporated into a personal computing device.

5. A transducer assembly comprising:
a first bracket element;
a second bracket element configured to couple to the first bracket element, wherein the first bracket element and the second bracket element, when coupled, form a first gear comprising an opening configured to receive a trolling motor shaft;
a second gear configured to mate with the first gear;
a transducer attached to the second gear; and
a motor configured to induce rotation of at least one of the first gear or the second gear and rotate the transducer relative to the trolling motor shaft to provide an adjustable field of view of the transducer.

6. The transducer assembly of claim 5, wherein the second gear is configured to rotate about the first gear.

7. The transducer assembly of claim 6, wherein the second gear is configured to enable a 360 degree field of view for the transducer attached to the second gear.

8. The transducer assembly of claim 5, wherein each of the first bracket element and the second bracket element is a semi-circle shape.

9. The transducer assembly of claim 5, further comprising one or more gear belts attached to the first gear and the second gear.

10. The transducer assembly of claim 9, wherein a first gear belt is attached to an outer edge of each of the first gear and the second gear and a second gear belt is attached to the trolling motor shaft.

11. The transducer assembly of claim 5, wherein the first bracket element and the second bracket element are coupled together via one or more screws.

12. A bracket assembly, comprising:
a bracket comprising a first bracket element and a second bracket element, the first bracket element configured to couple to the second bracket element, wherein the first bracket element and the second bracket element, when coupled, form a first gear comprising an opening configured to receive a trolling motor shaft;
an electric motor;
a second gear mounted on the electric motor, wherein the second gear is configured to mate with the first gear, and wherein the electric motor is configured to induce rotation of the second gear; and
a face plate configured to receive a transducer, wherein the face plate is arranged to rotate about the bracket when the electric motor induces rotation of the second gear.

13. The bracket assembly of claim 12, wherein the face plate is attached to at least one of the second gear and the electric motor.

14. The bracket assembly of claim 12, wherein the second gear is configured to rotate about the first gear.

15. The bracket assembly of claim 14, wherein the second gear is configured to enable a 360 degree field of view for the transducer attached to the second gear.

16. The bracket assembly of claim 12, wherein each of the first bracket element and the second bracket element is a semi-circle shape.

17. The bracket assembly of claim 12, further comprising one or more gear belts attached to the first and the second gear.

18. The bracket assembly of claim 17, wherein the one or more gear belts comprise a first gear belt attached to an outer edge of each of the first gear and the second gear and a second gear belt attached to the trolling motor shaft.

19. The bracket assembly of claim 12, wherein the first bracket element and the second bracket element are coupled together via one or more screws.

20. The bracket assembly of claim 12, further comprising a radial position digitizer configured to determine a position of the second gear in relation to the first gear.
